(19) United States
(12) Patent Application Publication
(10) Pub. No.: US 2003/0148152 A1
(43) Pub. Date: Aug. 7, 2003

(54) Method of operating fuel cell

(76) Inventor: Patrick John Morrisey, Uxbridge (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/239,557

(22) PCT Filed: Mar. 21, 2001
(86) PCT No.: PCT/GB01/01236

(30) Foreign Application Priority Data
Mar. 24, 2000 (GB) 0007290.0

(51) Int. Cl. H01M 8/18; H01M 8/20

(52) U.S. Cl. 429/15; 429/21; 429/30

(57) ABSTRACT

A method of operating a regenerative fuel cell which comprises two half-cells separated by a cation-exchange membrane, there being a halogen/halide electrolyte in one half of the cell, a sulfide/polysulfide in the other half of the cell and cations in both halves of the cell which act as charge carriers therebetween, wherein the state of charge of the sulfide/polysulfide electrolyte is in the range of from 1.8 to 2.5 for at least a part of the charge/discharge cycle over a plurality of cycles.

The present invention relates to the field of regenerative fuel cell (RFC) technology. In particular it relates to methods for the operation of RFCs which enhance their performance characteristics.

The manner in which RFCs are able to store and deliver electricity is well known to those skilled in the art. An example of an RFC is described in U.S. Pat. No. 4,485,154 which discloses an electrically chargeable, anionically active, reduction-oxidation system using a sulfide/polysulfide reaction in one half of the cell and an iodine/iodide, chlorine/chloride or bromine/bromide reaction in the other half of the cell. The two halves of the cell are separated by a cation exchange membrane.

The overall chemical reaction involved, for example, for the bromine/bromide-sulfide/polysulfide system is shown in Equation 1 below:

Br₂+S²⁻⇄2Br⁻+S Equation 1

However, within an RFC such as that described in U.S. Pat. No. 4,485,154, the reaction takes place in separate but dependent bromine and sulfur half-cells, the reactions of which are shown below in Equations 2 and 3:

Br₂+2e⁻⇄2Br⁻ Equation 2

S²⁻⇄2e⁻+S Equation 3

The sulfur produced in Equations 1 and 3 forms soluble polysulfide species (e.g. S₂²⁻, S₃²⁻, S₄²⁻ and S₅²⁻) in the presence of sulfide ions.

When the RFC is discharging, bromine is converted to bromide on the +ve side of the membrane and sulfide is converted to polysulfide on the −ve side of the membrane. Equation 1 goes from left to right and metal ions flow from the −ve side of the membrane to the +ve side of the membrane to complete the circuit. When the RFC is charging, bromide is converted to bromine on the +ve side of the membrane and polysulfide is converted to sulfide on the −ve side of the membrane. Equation 1 goes from right to left and metal ions flow from the +ve side of the membrane to the −ve side of the membrane to complete the circuit. The metal ions used are preferably alkali metal ions such as Na⁺ or K⁺. Salts of alkali metals are particularly suitable because they generally exhibit good solubility in aqueous solution.

The discharge/charge cycle described above will be repeated many times during the lifetime of the RFC. Surplus electricity may be stored by using it to charge the RFC and may then be released on demand by discharging the RFC through a load. Individual cells of this kind may also be electrically connected together so as to form an array which is capable of providing a greater voltage. Arrays of cells of this type are a common feature in the art of fuel cell technology.

It is clear that the identity of the chemical species present in the two electrolytes and their relative concentrations will vary as the discharge/charge cycle described above is repeated. In the context of the present specification, this variation is referred as a variation in the “state of charge” of the electrolytes. For the sulfide/polysulfide electrolyte the state of charge may be defined as the ratio of the total number of sulfur atoms which make up all sulfur species present in the sulfide/polysulfide electrolyte to the total number of units of negative charge carried by all sulfur species present in the sulfide/polysulfide electrolyte, one unit of negative charge being equivalent to the charge on an electron.

The state of charge of the sulfide/polysulfide electrolyte increases when the RFC is discharged. Sulfide ions are converted to sulfur resulting in a decrease in the total number of units of negative charge carried by all sulfur species present in the sulfide/polysulfide electrolyte whilst the total number of sulfur atoms which make up all those sulfur species remains constant.

Conversely, the state of charge of the sulfide/polysulfide electrolyte decreases when the RFC is charged. Sulfur is converted to sulfide resulting in an increase in the total number of units of negative charge carried by all sulfur species present in the sulfide/polysulfide electrolyte whilst the total number of sulfur atoms which make-up all those sulfur species remains constant.

The average sulfur species that should predominate at each of the corresponding states of charge are:

| State of Charge | Sulfur Species |
|---|---|
| 0.5 | S²⁻ |
| 1.0 | S₂²⁻ |
| 1.5 | S₃²⁻ |
| 2.0 | S₄²⁻ |
| 2.5 | S₅²⁻ |

In reality however, because of the differing stabilities of the sulfur species, the variation in the specification of the sulfide/polysulfide electrolyte with the change in the state of charge occurs in a much more complicated manner and several different sulfur species may co-exist to a greater or lesser degree at any particular state of charge.

Thus it is known that when a halogen/halide-sulfide/polysulfide RFC is repeatedly discharged and charged the state of charge of the sulfide/polysulfide electrolyte may vary from 0.5 to 2.5 and back again. Whilst it is theoretically possible to increase the state of charge to values higher than 2.5 in practice this is never allowed to happen because the sulfur produced by oxidation of the sulfide ions begins to precipitate out of solution. The formation of solid sulfur precipitates within the sulfide/polysulfide electrolyte is highly undesirable because it precipitates onto the electrode causing the voltage to drop off rapidly. It may also cause scaling within the apparatus, blockage of electrolyte ducts and contamination of the membranes.

In actual fact, up to the time of the present invention, when a halogen/halide-sulfide/polysulfide RFC was repeatedly discharged and charged the state of charge of the sulfide/polysulfide electrolyte was only allowed to vary within the range of from 0.5 to approximately 1.7. Operation of the RFC above approximately 1.7 was avoided because above this value there exists the likelihood of the formation of colloidal sulfur within the sulfide/polysulfide electrolyte. For example, when Na⁺ is used as the counterion in the sulfide/polysulfide electrolyte, the onset of colloid formation occurs when the state of charge is approximately 2.2. The formation of colloidal sulfur is a precursor to the precipitation of solid sulfur which will occur if the state of charge continues to increase. The range of values for the state of charge between the onset of colloidal sulfur formation and the onset of sulfur precipitation is referred to herein as the “colloidal phase”. Since the colloidal phase represents an area within the state of charge spectrum which is close to the onset of precipitation this region has been strictly avoided and the operation of RFCs of this type has been restricted to states of charge below approximately 1.7. Also, when in the colloidal phase, the viscosity of the electrolyte increases which is usually an undesirable effect.

It should be noted that when the sulfide/polysulfide and halogen/halide electrolytes for a halogen/halide-sulfide/polysulfide RFC are first introduced into the system they may consist of, for example, aqueous Na₂S₅ and aqueous NaBr respectively. Thus, at the very start of the RFC's life, the sulfide/polysulfide electrolyte may be in a state of charge as high as 2.5. However, under present practices, the RFC would immediately be charged so that the state of charge of the sulfide/polysulfide electrolyte decreases to below approximately 1.7 and the RFC would be subsequently operated in repeating charge/discharge cycles without the state of charge of the sulfide/polysulfide electrolyte rising back above approximately 1.7.

The inventors of the presently claimed invention have now discovered that operating the RFC in repeating charge/discharge cycles such that the state of charge of the sulfide/polysulfide electrolyte enters within the range of from 1.8 to 2.5 provides unexpected improvements in the operation of the cell even though this range for the state of charge may encompass at least a part of the colloidal phase of the sulfide/polysulfide electrolyte. Below a state of charge of 1.8 the advantages described below are not obtained, although in practice the state of charge may be allowed to drop below this value as the cell is charged. Above a state of charge of 2.5 sulfur precipitation occurs.

A number of factors may affect the overall efficiency of operation of an RFC. In the case of a halogen/halide-sulfide/polysulfide RFC such as that described above, one of the most important factors which results in a decrease in cell efficiency is the diffusion of unwanted species across the membrane. Although a cation selective ion-exchange membrane is used, during extended cycling of the cell some anionic species diffuse through the membrane. Thus, in the case of a bromine/bromide-sulfide/polysulfide RFC, sulfide and polysulfide ions diffuse through the membrane from the sulfide/polysulfide electrolyte into the bromine/bromide electrolyte where they will be oxidised by the bromine to form sulfate ions as shown in equation 4 below:

HS⁻+4Br₂+4H₂O→8Br⁻+So₄²⁻+9H⁺ Equation 4

The oxidation of the sulfide goes beyond that which occurs during normal operation of the RFC. That is to say, the sulfide ions are oxidised all the way to sulfate ions and consequently consume four bromine molecules per sulfide ion rather than the normal one bromine molecule per sulfide ion which is consumed in the reaction scheme of Equation 1. As a result, the bromine/bromide electrolyte becomes discharged to a greater extent than the sulfide/polysulfide electrolyte. Thus, the electrolytes become unbalanced and when the cell is discharging there is insufficient bromine present to complete the discharge cycle. As a result, the voltage generated by the cell begins to decline earlier in the discharge cycle than when the electrolytes are balanced, i.e. the discharge cycle is shorter than the charge cycle. In order to compensate for the unbalancing effect of sulfide diffusion through the membrane, some kind of rebalancing process is generally necessary. In the context of the present specification, when the term “balanced” is used to describe the electrolytes it means that the concentrations of the reactive species within the electrolytes are such that both half-cell reactions are able to progress substantially to completion without one reaching completion before the other. Similarly, in the context of the present specification, the term “rebalancing” refers to a process which alters the concentration of one or more reactive species in one or both of the electrolytes so as to return said electrolytes to a balanced state or so as to maintain said electrolytes in a balanced state. Another disadvantageous result of sulfide crossover is the accumulation of sulphate ions in the bromine/bromide electrolyte. When a certain concentration of sulphate ions is reached, sulphate salts may begin to precipitate out of the bromine/bromide electrolyte. The presence of such precipitates is undesirable since it may cause scaling within the apparatus, blockage of electrolyte ducts and contamination of the electrodes and/or membranes. Therefore some kind of process for removal of sulphate ions is generally necessary.

It has unexpectedly been found that when the RFC is operated such that the state of charge of the sulfide/polysulfide electrolyte is in the range of from 1.8 to 2.5 there is a significant reduction in the diffusion of sulfide species across the membrane.

This is extremely advantageous because it reduces the tendency for the electrolytes to become unbalanced and reduces the build up of sulfate ions in the halogen/halide electrolyte. This consequently reduces the need for the incorporation of rebalancing and sulfate removal processes into the RFC which results in a decrease in capital and maintenance costs.

Another factor which affects the efficiency of an RFC is the size of the overpotentials for the chemical conversions which occur within the cell. The overpotential for a particular chemical conversion is the difference between the potential of the electrode at which the conversion occurs when current is not flowing (i.e. when the system is in equilibrium and no chemical conversion occurs) and the potential of that electrode when current is flowing (i.e. when the system is no longer in equilibrium and chemical conversion occurs). Clearly it is advantageous for the overpotentials to be as small as possible so that the RFC delivers as high a voltage as possible. In the case of a bromine/bromide-sulfide/polysulfide RFC such as that described above, the overpotential for the interconversion of the sulfur species is considerably higher than that for the interconversion of the bromine species and therefore has a greater effect on the overall efficiency of the RFC.

It has also surprisingly been found that operation of the RFC such that the state of charge of the sulfide/polysulfide electrolyte is in the range of from 1.8 to 2.5 results in a significant reduction in the overpotential associated with the conversion of sulfur to sulfide when carbon-based electrodes are used. This decrease in the overpotential results in an increase in the efficiency of the RFC.

Accordingly, the present invention provides a method of operating a regenerative fuel cell (RFC) which comprises two half-cells separated by a cation-exchange membrane, there being a halogen/halide electrolyte in one half of the cell, a sulfide/polysulfide electrolyte in the other half of the cell and cations in both halves of the cell which act as charge carriers therebetween; characterised in that the state of charge of the sulfide/polysulfide electrolyte is in the range of from 1.8 to 2.5 for at least a part of the charge/discharge cycle over a plurality of charge/discharge cycles, wherein the state of charge of the sulfide/polysulfide electrolyte is defined as the ratio of the total number of sulfur atoms which make up all sulfur species present in the sulfide/polysulfide electrolyte to the total number of units of negative charge carried by all sulfur species present in the sulfide/polysulfide electrolyte, one unit of negative charge being equivalent to the charge on an electron.

Whilst greatest benefit from the present invention may be obtained by maintaining the state of charge in the range of from 1.8 to 2.5, it will be understood that the benefit of the present invention will still be obtained when the state of charge varies over a wider range but nevertheless enters within the range of from 1.8 to 2.5 for at least a part of the charge/discharge cycle.

Preferably the state of charge of the sulfide/polysulfide electrolyte is in the range of from 2.0 to 2.5, more preferably within the range of from 2.2 to 2.5 for at least a part of the charge/discharge cycle over a plurality of charge/discharge cycles.

In order to ascertain when the state of charge is within the stated range it is necessary to provide means for monitoring the state of charge. This can be achieved by monitoring the electrolyte using UV/VIS spectroscopy. Standard sampling methods cannot be used due to the strong absorbance characteristics of the electrolyte but measurements may be made by use of an Attenuated Total Reflection (ATR) probe. The absorbance levels of four peaks are monitored with time. These peaks are at 230 nm (corresponding to sulphide S²⁻ ions), 268 nm and 310 nm (corresponding to elemental sulphur S which is dissolved as Sₓ²⁻ ions) and 249 nm (corresponding to total soluble sulphur content, i.e. Sₓ²⁻ and S²⁻). As the cell is cycled the sulphide concentration increases during the charge cycle and decreases during the discharge cycle. Thus, the corresponding peak at 230 nm also increases during the charge cycle and decreases during the discharge cycle. The opposite is true for the soluble sulphur concentration and the corresponding peaks at 268 nm and 310 nm. The total soluble sulphur content remains constant, as does its peak at 249 nm. Since the total number of sulphur atoms is known and the negative charge is carried by the sulphide ions the state of charge can be monitored by monitoring the change in the sulphide peak at 230 nm.

The method of the present invention may equally be applied to an array of repeating cell structures which are electrically connected.

The present invention also includes within its scope an electrochemical process for energy storage and power delivery comprising the steps of:

(i) maintaining and circulating electrolyte flows in a single cell or in an array of repeating cell structures, each cell with a chamber (+ve chamber) containing an inert +ve electrode and a chamber (−ve chamber) containing an inert −ve electrode, the chambers being separated from one another by an ion exchange membrane, the electrolyte circulating in the −ve chamber of each cell during power delivery containing sulfide, and the electrolyte circulating in the +ve chamber during power delivery containing bromine as an oxidising agent, and

(ii) restoring or replenishing the electrolytes in the +ve and −ve chambers by circulating the electrolyte from each chamber to storage means comprising a volume of electrolyte greater than the cell volume for extended delivery of power over a longer discharge cycle than the cell volume alone would permit,

characterised in that the state of charge of the sulfide electrolyte is in the range of from 1.8 to 2.5 for at least a part of the charge/discharge cycle over a plurality of charge/discharge cycles, wherein the state of charge of the sulfide electrolyte is defined as the ratio of the total number of sulfur atoms which make up all sulfur species present in the sulfide electrolyte to the total number of units of negative charge carried by all sulfur species present in the sulfide electrolyte, one unit of negative charge being equivalent to the charge on an electron.

The present invention will be further described with reference to the accompanying drawings in which:

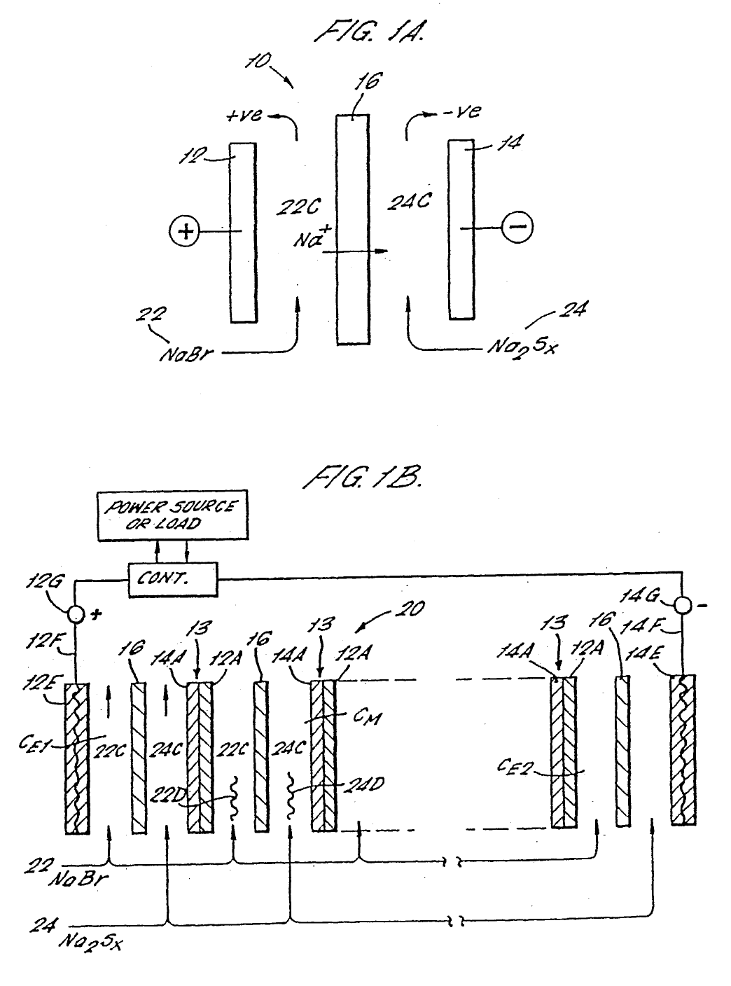

FIG. 1A is a schematic view of a basic electrochemical reduction-oxidation cell in which a sulfide/polysulfide reaction is carried out in one half of the cell and a bromine/bromide reaction is carried out in the other half of the cell;

FIG. 1B is a diagram of cell arrays using the system of FIG. 1A;

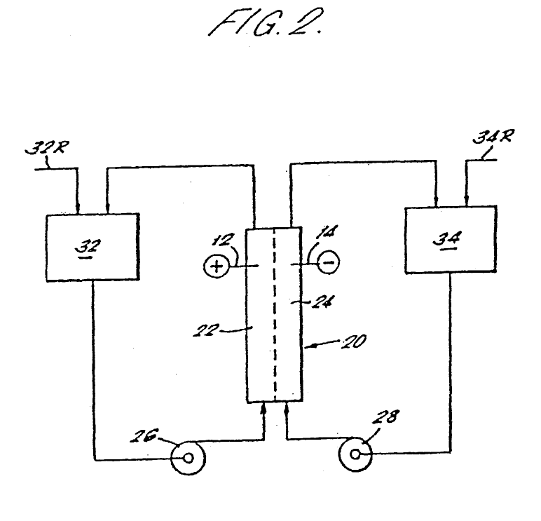

FIG. 2 is a block diagram of a fluid flow system using the cell of FIG. 1A;

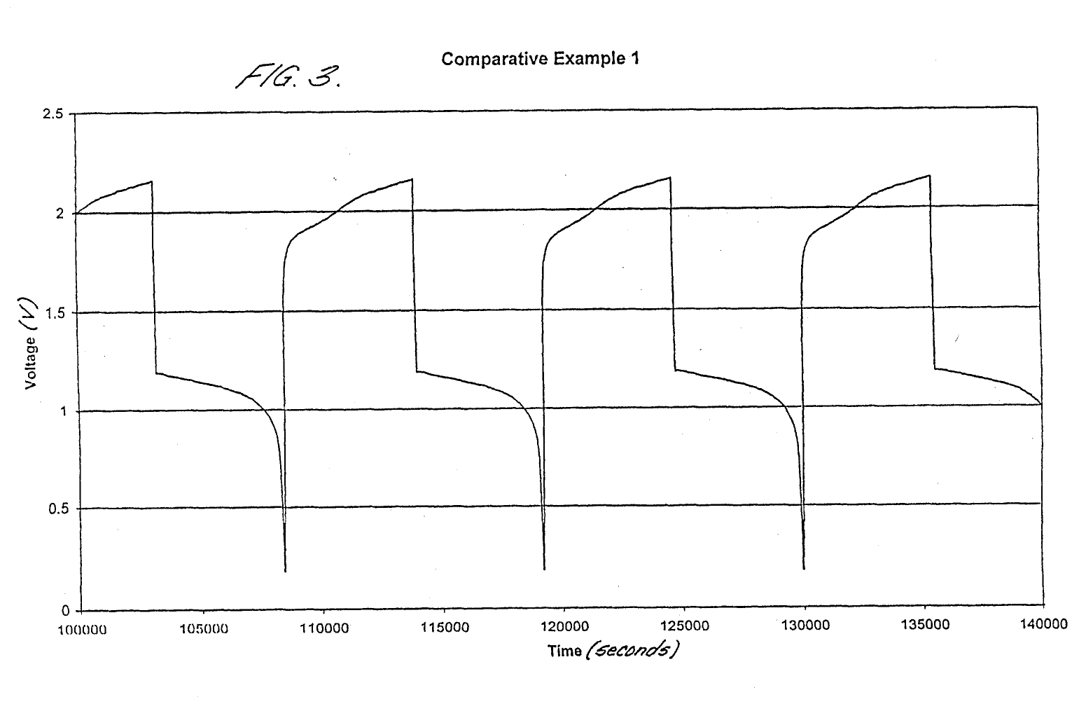

FIG. 3 is a plot of voltage versus time for the cell of Comparative Example 1.

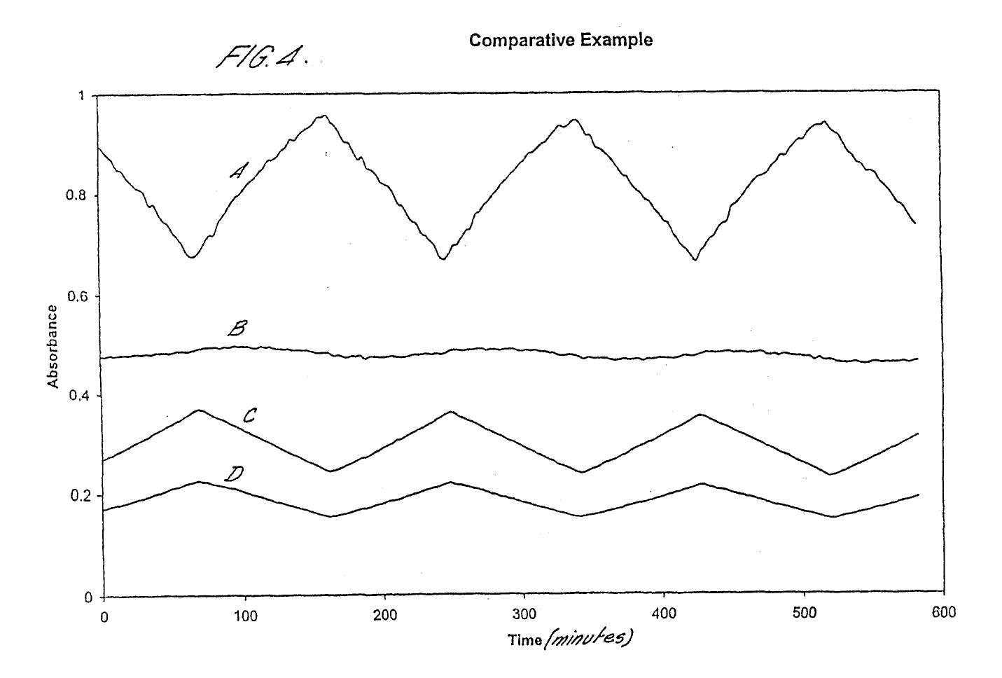

FIG. 4 is a plot of absorbance versus time at various wavelengths for the cell of Comparative Example 1.

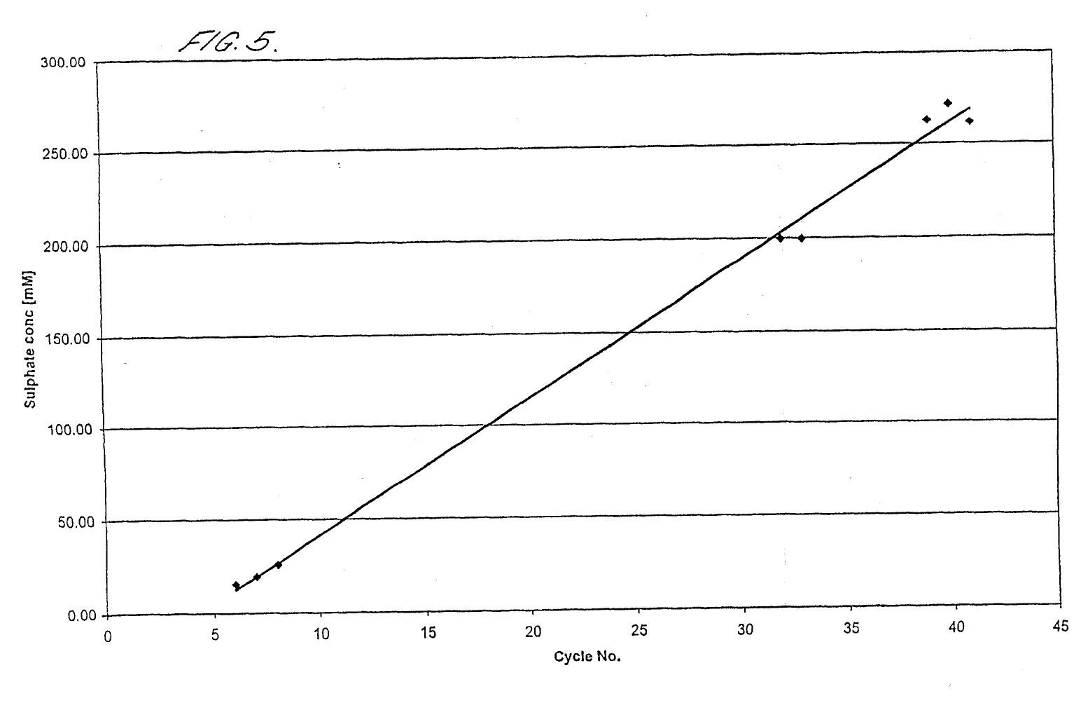

FIG. 5 is a plot of sulphate concentration versus cycle number for the cell of Comparative Example 1.

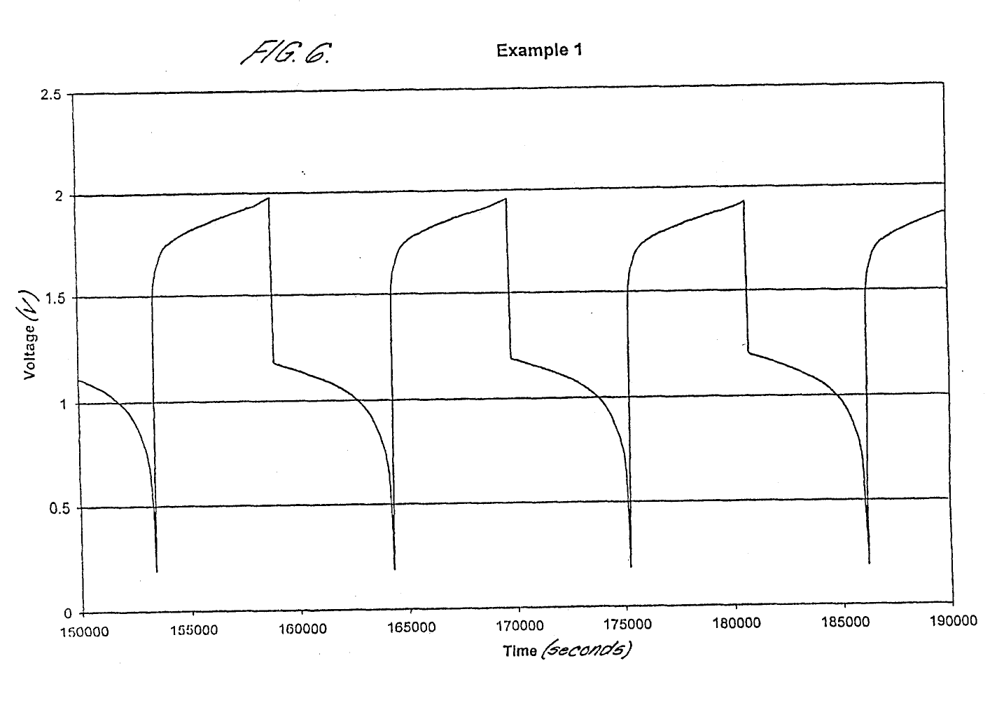

FIG. 6 is a plot of voltage versus time for the cell of Example 1.

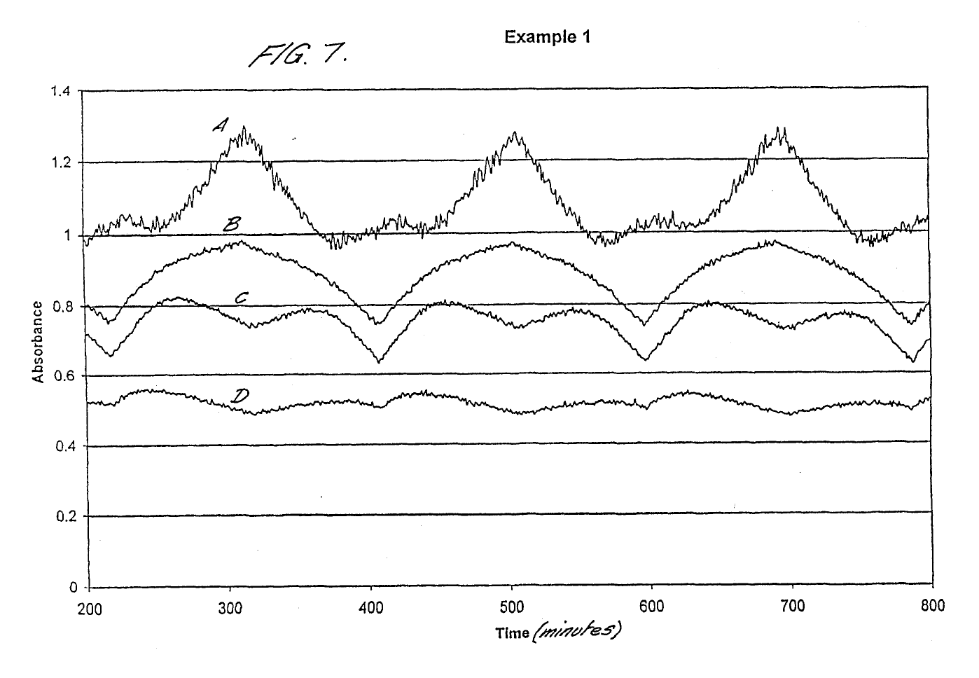

FIG. 7 is a plot of absorbance versus time at various wavelengths for the cell of Example 1.

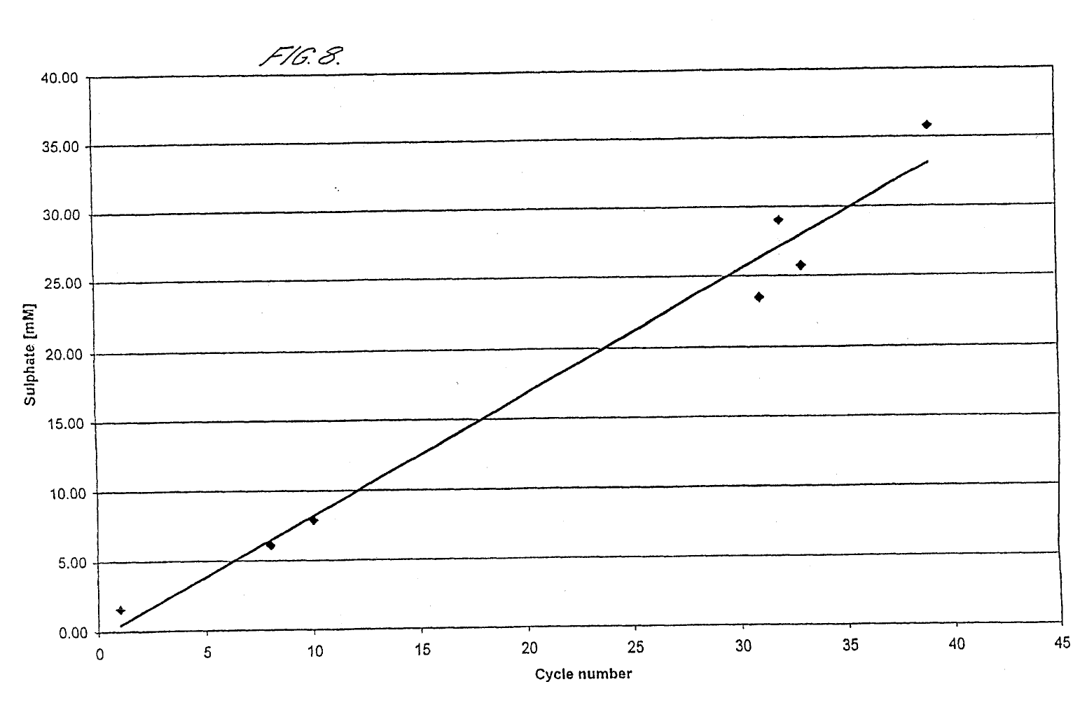

FIG. 8 is a plot of sulphate concentration versus cycle number for the cell of Example 1.

FIG. 1A shows a cell 10 with a positive (+^{ve}) electrode 12 and a negative (−^{ve}) electrode 14 and a cation exchange membrane 16 which may be formed from a fluorocarbon polymer with sulfonic acid functional groups to provide charge carriers. The membrane 16 acts to separate the +^{ve} and −^{ve} sides of the cell 10 and is selected to minimize migration of bromine from the +^{ve} side to the −^{ve} side and to minimize migration of S²⁻ ions from the −^{ve} side to the +^{ve} side. An aqueous solution 22 of NaBr is provided in a chamber 22C formed between the +^{ve} electrode 12 and the membrane 16 and an aqueous solution 24 of Na₂Sₓ is provided in a chamber 24C formed between the −^{ve} electrode 14 and the membrane 16. A K₂Sₓ solution, which is more soluble and more expensive than the Na₂Sₓ solutions, may also used.

When the cell is in the discharged state, a solution of NaBr of up to 6.0 molar concentration exists in the chamber 22C of the cell and a solution of Na₂S₅ at 0.5 to 1.5 molar, exists in chamber 24C of the cell. Higher molarity is possible with K₂S₅.

As the cell is charged, Na⁺ ions are transported through the cation membrane 16, as shown in FIG. 1A, from the +^{ve} to the −^{ve} side of the cell. Free bromine is produced via oxidation of the bromide ions at the +^{ve} electrode and dissolves as a tribromide or pentabromide ion. Sulfur is reduced at the −^{ve} electrode and the pentasulfide, Na₂S₅, salt eventually becomes the monosulfide as the charging proceeds to completion. At the +^{ve} side the following reaction occurs,

2Br⁻ [symbol] Br₂+2e⁻

and at the −^{ve} side the following reaction occurs,

S+2e⁻ [symbol] S²⁻.

The membrane separates the two electrolytes and prevents bulk mixing and also retards the migration of sulfide ions from the −^{ve} side to the +^{ve} side, and the migration of Br⁻ and Br₂ from the +^{ve} to the −^{ve} side. As mentioned above, diffusion of the sulfide ions results in coulombic loss as the electrolytes become unbalanced and results in the oxidation of some of the sulfide content of the system to sulfate ions.

When providing power, the cell is discharging. During this action, reversible reactions occur at the two electrodes. At the +^{ve} side electrode 12, bromine is reduced to Br⁻, and at the −^{ve} electrode, the S²⁻ ion is oxidized to molecular S. The electrons produced at the −^{ve} electrode form the current through a load. The chemical reaction at the +^{ve} electrode produces 1.06 to 1.09 volts and the chemical reaction at the −^{ve} electrode produces 0.48 to 0.52 volts. The combined chemical reactions produce an open circuit voltage of 1.54 to 1.61 volts per cell.

The energy density of the bromine/sulfur couple will be limited by the permissible maximum concentration of the Br₂ in the +^{ve} side, not by the solubilities of the constituent salts, such as NaBr and Na₂S, which are high.

The reacting ions are S²⁻ and Br⁻ going back and forth to the elemental stage during the oxidation/reduction processes. The cation which is associated with them essentially takes no part in the energy producing process. Hence, a cation of “convenience” is chosen. Sodium or potassium are preferred choices. Sodium and potassium compounds are plentiful, they are inexpensive and have high water solubilities. Lithium and ammonium salts are also possibilities, but at higher costs.

FIG. 1B shows an array 20 of multiple cells connected in electrical series and fluid parallel. Multiple mid-electrodes 13 (each one having a +^{ve} electrode side 12A and −^{ve} electrode side 14A) and end electrodes 12E (+^{ve}) and 14E (−^{ve}) are spaced out from each other by membranes 16 and screen or mesh spacers (22D, 24D) in all the cell chambers 22C, 24C, (portions of two of which 22D, 24D are shown by way of example) to form end cells C_{El} and C_{E2} and an array of mid cells C^{M}, (typically 10-20; but note much smaller and much higher numbers of cells can be accommodated). The end electrodes 12E (+^{ve}) and 14E (−^{Ve}) have internal conductors 12F and 14F (typically copper screens) encapsulated therein and leading to external terminals 12G, 14G which are connected to external loads (e.g. to motor(s) via a control circuit (CONT), the motor(s) may be used to drive a vehicle) or power sources (e.g. utility power grid when used as a load-levelling device).

FIG. 2 shows a free flow system, a power generation/storage system utilizing one or more of the batteries or cell array formats 20. Each cell 20 receives electrolyte through pumps 26 and 28 for the NaBr and Na₂S₅ solutions (22 and 24, respectively). The electrolytes 22 and 24 are stored in containers 32 and 34. The tanks 32, 34 can be replaced with freshly charged electrolyte by substituting tanks containing fresh electrolyte and/or refilling them from charged supply sources via lines 32R, 34R with corresponding lines (not shown) provided for draining spent (discharged) reagent. The electrolytes 22 and 24 are pumped from tanks 32 and 34, respectively, into the respective chambers 22C and 24C by means of pumps 26 and 28. The present invention will be further described with reference to the following examples:

### COMPARATIVE EXAMPLE 1

A regenerative fuel cell having sulfide/polysulfide and bromine/bromide electrolytes was set up. The cell apparatus had the following specifications:

| | |
|---|---|
| electrode material | polyethylene impregnated |
| | with activated carbon |
| electrode area | 174 cm² |
| membrane material | Nafion 115 ™ |
| membrane-electrode gap | 1 mm |

The electrolyte provided for circulation through the negative half of the cell was initially made up of:

| | | |
|---|---|---|
| Na₂S_{3.7} | 1.3 | M |
| NaOH | 1 | M |
| NaBr | 1 | M |

The electrolyte provided for circulation through the positive half of the cell was initially made up of:

NaBr5M

The total volume of each electrolyte was 300 ml. After an initial charging period, the cell was subjected to successive charge/discharge cycles such that the state of charge of the sulfide/polysulfide electrolyte remained in the range of from 1.60 to 0.96.

The operating conditions of the cell were as follows:

| | |
|---|---|
| current density | 60 mA/cm² |
| cycle time | 3 hours (i.e. 1.5 hours |
| | charge and 1.5 hours |
| | discharge) |

FIG. 3 shows a plot of the voltage of the cell over a number of cycles after the cell has been running for some time.

The state of charge of the cell was monitored by UV/VIS spectroscopy. FIG. 4 shows plots of absorbance versus time at 230 nm (plot A, corresponding to sulphide), 249 nm (plot B, corresponding to total sulphur), 268 nm and 310 nm (plots C and D respectively, corresponding to sulphur).

The build-up of sulphate in the bromine/bromide electrolyte was monitored over about 45 cycles by ion chromatography. FIG. 5 shows a plot of the increase in sulphate build-up in the bromine/bromide electrolyte versus the cycle number. It was found that the average sulphate build-up was 7 mM/cycle.

The cell was found to operate with an average cell efficiency of 49%.

### EXAMPLE 1

A regenerative fuel cell having sulfide/polysulfide and bromine/bromide electrolytes was set up. The cell apparatus had the following specifications:

| | |
|---|---|
| electrode material | polyethylene impregnated |
| | with activated carbon |
| electrode area | 173 cm² |
| membrane material | Nafion 115 ™ |
| membrane-electrode gap | 1 mm |

The electrolyte provided for circulation through the negative half of the cell was initially made up of:

| | | |
|---|---|---|
| Na₂S₅ | 1.3 | M |
| NaBr | 1 | M |

The electrolyte provided for circulation through the positive half of the cell was initially made up of:

NaBr5M

The volume of each electrolyte was 300 ml.

The cell was subjected to successive charge/discharge cycles such that the state of charge of the sulfide/polysulfide electrolyte remained in the range of from 1.3 to 2.15.

| | |
|---|---|
| current density | 60 mA/cm² |
| cycle time | 3 hours (i.e. 1.5 hours charge |
| | and 1.5 hours discharge) |

The operating conditions of the cell were as follows:

FIG. 6 shows a plot of the voltage of the cell over a number of cycles after the cell has been running for some time. It can be seen that the charging potential is significantly reduced for this cell as compared with that of comparative example 1.

The state of charge of the cell was monitored by UV/VIS spectroscopy. FIG. 7 shows plots of absorbance versus time at 230 nm (plot A, corresponding to sulphide), 249 nm (plot B, corresponding to total sulphur), 268 nm and 310 nm (plots C and D respectively, corresponding to sulphur). In this case the total sulphur content appears to fluctuate. This is because only dissolved sulphur is monitored and when the cell is cycled at a high state of charge some of the sulphur forms colloidal sulphur as the cell is discharged resulting in a decrease in the total amount of dissolved sulphur species.

The build-up of sulphate in the bromine/bromide electrolyte was monitored over about 45 cycles by ion chromatography. FIG. 8 shows a plot of the increase in sulphate build-up in the bromine/bromide electrolyte versus the cycle number. It was found that

the average sulphate build-up was 1 mM/cycle. The cell was found to operate with an average cell efficiency of 56%.

The results of these experiments clearly demonstrate that operating the RFC such that the state of charge of the sulfide/polysulfide electrolyte enters within the range of from 1.8 to 2.5 substantially reduces the rate of diffusion of sulfide species through the membrane and also significantly reduces the overpotential on the negative side of the cell during charging resulting in an increase in the overall efficiency of the cell.

1. A method of operating a regenerative fuel cell (RFC) which comprises two half-cells separated by a cation-exchange membrane, there being a halogen/halide electrolyte in one half of the cell, a sulfide/polysulfide electrolyte in the other half of the cell and cations in both halves of the cell which act as charge carriers therebetween; characterised in that the state of charge of the sulfide/polysulfide electrolyte is in the range of from 1.8 to 2.5 for at least a part of the charge/discharge cycle over a plurality of charge/discharge cycles, wherein the state of charge of the sulfide/polysulfide electrolyte is defined as the ratio of the total number of sulfur atoms which make up all sulfur species present in the sulfide/polysulfide electrolyte to the total number of units of negative charge carried by all sulfur species present in the sulfide/polysulfide electrolyte, one unit of negative charge being equivalent to the charge on an electron.

2. A method as claimed in claim 1 wherein the state of charge of the sulfide/polysulfide electrolyte is in the range of from 2.0 to 2.5 for at least a part of the charge/discharge cycle over a plurality of charge/discharge cycles.

3. A method as claimed in claim 1 or claim 2 wherein the state of charge of the sulfide/polysulfide electrolyte is in the range of from 2.2 to 2.5 for at least a part of the charge/discharge cycle over a plurality of charge/discharge cycles.

4. A method as claimed in any one of claims 1 to 3 wherein the regenerative fuel cell comprises an array of repeating cell structures which are electrically connected.

5. An electrochemical process for energy storage and power delivery comprising the steps of:
(i) maintaining and circulating electrolyte flows in a single cell or in an array of repeating cell structures, each cell with a chamber (+ve chamber) containing an inert +ve electrode and a chamber (−ve chamber) containing an inert −ve electrode the chambers being separated from one another by an ion exchange membrane, the electrolyte circulating in the −ve chamber of each cell during power delivery containing sulfide, and the electrolyte circulating in the +ve chamber during power delivery containing bromine as an oxidising agent, and
(ii) restoring or replenishing the electrolytes in the +ve and −ve chambers by circulating the electrolyte from each chamber to storage means comprising a volume of electrolyte greater than the cell volume for extended delivery of power over a longer discharge cycle than the cell volume alone would permit characterised in that the state of charge of the sulfide electrolyte is in the range of from 1.8 to 2.5 for at least a part of the charge/discharge cycle over a plurality of charge/discharge cycles, wherein the state of charge of the sulfide electrolyte is defined as the ratio of the total number of sulfur atoms which make up all sulfur species present in the sulfide electrolyte to the total number of units of negative charge carried by all sulfur species present in the sulfide electrolyte, one unit of negative charge being equivalent to the charge on an electron.

6. A method of operating a regenerative fuel cell substantially as hereinbefore described with reference to Example 1.
